(19) United States
(12) Patent Application Publication
(10) Pub. No.: US 2024/0292173 A1
(43) Pub. Date: Aug. 29, 2024

(54) CONTROL APPARATUS FOR CAUSING SPEAKER TO REPRODUCE SOUND CORRESPONDING TO LISTENING POINT, CONTROL METHOD, AND NON-TRANSITORY COMPUTER READABLE MEDIUM

(71) Applicant: CANON KABUSHIKI KAISHA, Tokyo (JP)

(72) Inventor: MASANOBU FUNAKOSHI, Kanagawa (JP)

(21) Appl. No.: 18/587,771

(22) Filed: Feb. 26, 2024

(30) Foreign Application Priority Data
Feb. 28, 2023 (JP) 2023-029726

(51) Int. Cl. H04S 7/00; G06T 17/00

(52) U.S. Cl. CPC H04S 7/303; G06T 17/00

(57) ABSTRACT

A control apparatus obtains a position of a listening point, calculates a respective position of each of one or more virtual sound sources with respect to the obtained position of the listening point, calculates positions of a plurality of speakers with respect to the obtained position of the listening point, the plurality of speakers being located around the listening point, generates an output signal to be output to each of the plurality of speakers based on one or more sound source signals each output from the one or more virtual sound sources, the respective position of each of the one or more virtual sound sources with respect to the position of the listening point, and the positions of the plurality of speakers with respect to the position of the listening point, and causes each of the plurality of speakers to reproduce sound corresponding to the output signal.

### BACKGROUND

### Field of the Disclosure

The present disclosure relates to a control apparatus for causing a speaker to reproduce sound corresponding to a listening point, a control method, and a non-transitory computer readable medium.

### Description of the Related Art

There is a system in which a sound field that enables a listener located at a listening point to be immersed in a virtual world is generated by rendering sound output from a virtual sound source located in the virtual world for a plurality of speakers located around the listening point. Japanese Patent Application Laid-Open No. 2009-44261 discusses a technique for calculating, for each virtual sound source, a distribution ratio of sound signals to be supplied to speakers based on a positional relationship of the speakers with respect to a listening point and the virtual sound source located at a fixed position with respect to the listening point, and distributing the signals to the speakers at the calculated distribution ratio, to thereby generate a sound field.

In the actual world, even when a listening point moves, sound is constantly heard from a position where a sound source is present. It may be desirable for a user to hear sound output from the virtual sound source at the position where the virtual sound source is present even after the listening point has moved. However, if the listening point moves within a listening range surrounded by speakers, the direction of the virtual sound source as viewed from the listening point varies and the positional relationship between the listening point and each speaker also varies. Accordingly, if a sound field is generated under the same conditions as those before the listening point moves, an unnatural sound field is generated, which inhibits a sense of immersion in a virtual world.

However, in the technique discussed in Japanese Patent Application Laid-Open No. 2009-44261, when the listening point moves, the position of the virtual sound source as viewed from the listening point is fixed in the generation of the sound field, which makes it difficult to reproduce the sound field from a virtual sound source located at a certain position like in the actual world in accordance with the movement of the listening point.

### SUMMARY

According to an aspect of the present disclosure, a control apparatus includes one or more memories storing instructions, and one or more processors executing the instructions to obtain a position of a listening point, calculate a respective position of each of one or more virtual sound sources with respect to the obtained position of the listening point, calculate positions of a plurality of speakers with respect to the obtained position of the listening point, the plurality of speakers being located around the listening point, generate an output signal to be output to each of the plurality of speakers based on one or more sound source signals each output from the one or more virtual sound sources, the respective position of each of the one or more virtual sound sources with respect to the position of the listening point, and the positions of the plurality of speakers with respect to the position of the listening point, and cause each of the plurality of speakers to reproduce sound corresponding to the output signal.

Further features of various embodiments of the present disclosure will become apparent from the following description of exemplary embodiments with reference to the attached drawings.

### BRIEF DESCRIPTION OF THE DRAWINGS

FIGS. 1A to 1C each illustrate an example of movement of a listening point.

FIG. 2 is a block diagram illustrating a functional configuration example of a control apparatus according to a first exemplary embodiment.

FIG. 3 is a block diagram illustrating a hardware configuration example of the control apparatus.

FIG. 4 illustrates a data configuration example of virtual sound source information.

FIG. 5 illustrates a data configuration example of speaker information.

FIG. 6 illustrates a data configuration example of speaker set information.

FIG. 7 is a flowchart illustrating an example of sound field generation processing to be performed by the control apparatus.

FIG. 8 is a flowchart illustrating an example of virtual sound source relative coordinates calculation processing.

FIG. 9 is a flowchart illustrating an example of sound source rendering processing.

FIG. 10 is a block diagram illustrating a functional configuration example of a control apparatus according to a second exemplary embodiment.

FIG. 11 is a flowchart illustrating an example of sound field/video image generation processing to be performed by the control apparatus.

FIG. 12 is a flowchart illustrating an example of sound source rendering processing.

FIG. 13 illustrates a data configuration example of virtual sound source information.

### DESCRIPTION OF THE EMBODIMENTS

Exemplary embodiments of the present disclosure will be described below with reference to the drawings. The following exemplary embodiments are not intended to limit every embodiment of the present disclosure, and not all combinations of features described in the exemplary embodiments are necessarily deemed to be essential. The same components are denoted by the same reference numerals.

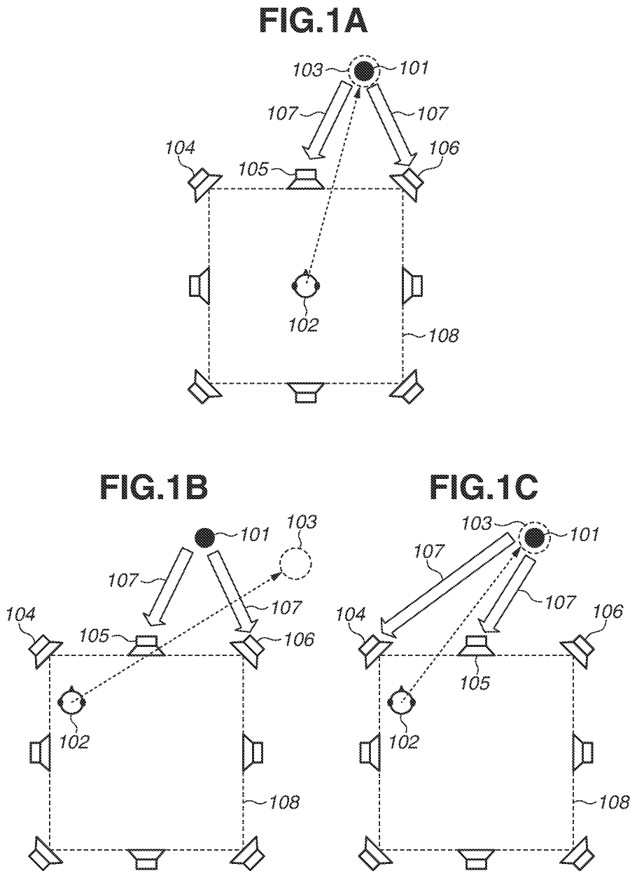

A virtual sound source and a sound image of the virtual sound source when a listening point moves will be described. FIGS. 1A to 1C each illustrate an example of movement of the listening point, and schematically illustrate a relationship among the listening point, the virtual sound source, the sound image of the virtual sound source, and a speaker layout. FIGS. 1A to 1C each illustrate a virtual sound source 101, a listening point 102, a sound image 103 of the virtual sound source 101, speakers 104, 105, and 106, and a listening range 108. An image of a distribution of signals from the virtual sound source 101 to the speakers 104, 105, and 106 is indicated by arrows 107.

FIG. 1A illustrates an example of a positional relationship among the listening point 102, the virtual sound source 101, and the sound image 103 of the virtual sound source 101 when the listening point 102 is located at the center of the listening range 108. In this case, signals from the virtual sound source 101 are appropriately distributed to the speakers 105 and 106 as indicated by the arrows 107, thereby making it possible to present the sound image 103 to be sensed at the listening point 102 at the position where the virtual sound source 101 is located.

Assume that the listening point 102 has moved within the listening range 108 as illustrated in FIG. 1B from the state illustrated in FIG. 1A. In this case, if the signals from the virtual sound source 101 are distributed to the speakers 105 and 106 in the same manner as in the example illustrated in FIG. 1A, the sound image 103 to be sensed at the listening point 102 deviates from the position of the virtual sound source 101 as illustrated in FIG. 1B.

In the exemplary embodiments to be described below, the distribution of signals from the virtual sound source 101 to each speaker is appropriately changed so that the sound image 103 to be sensed at the listening point 102 matches the position of the virtual sound source 101 in accordance with the movement of the listening point 102. For example, as illustrated in FIG. 1C, the distribution of signals is changed such that the signals from the virtual sound source 101 are appropriately distributed to the speakers 104 and 105 as indicated by the arrows 107 in accordance with the movement of the listening point 102. As a result, the sound image 103 can be presented at the position of the virtual sound source 101 even after the listening point 102 has moved. For convenience of explanation, FIGS. 1A to 1C illustrate an example where speakers are arranged two-dimensionally. However, the speaker layout is not limited to the two-dimensional arrangement. The exemplary embodiments to be described below can also be applied to a case where speakers are arranged three-dimensionally.

A first exemplary embodiment illustrates an example where sound source signals output from a virtual sound source located at an arbitrary position in a virtual space are appropriately distributed to speakers in accordance with the movement of a listening point, to thereby generate a sound field. In the first exemplary embodiment, for ease of explanation, assume that the sound source signals output from the sound source whose position in the virtual space is known in advance can be obtained.

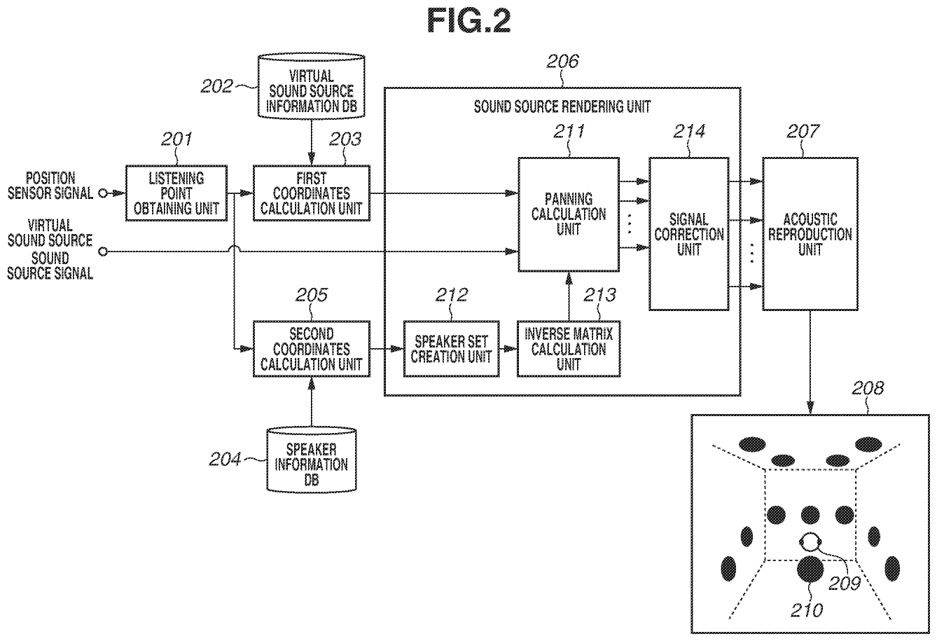

FIG. 2 is a block diagram illustrating a functional configuration example of a control apparatus according to the first exemplary embodiment. The control apparatus according to the first exemplary embodiment includes a listening point obtaining unit 201, a virtual sound source information database (DB) 202, a first coordinates calculation unit 203, a speaker information DB 204, and a second coordinates calculation unit 205. The control apparatus according to the first exemplary embodiment also includes a sound source rendering unit 206 and an acoustic reproduction unit 207.

The listening point obtaining unit 201 analyzes signals from a position sensor (not illustrated) configured to detect a position, and obtains the position of the listening point. Examples of the position sensor include an infrared sensor for directly detecting the position of a listener (listening point) with an infrared ray, and a sensor for detecting a position using near-field communication by adding a radio tag to a target listening point. The position sensor is not limited to these examples, and various sensors can be used without departing from the gist of the present disclosure.

The virtual sound source information DB 202 stores virtual sound source information about one or more virtual sound sources located in the virtual space. The virtual sound source information includes information such as virtual sound source coordinates indicating the position where the virtual sound source is located. The virtual sound source information will be described in detail below.

The first coordinates calculation unit 203 calculates relative coordinates of each virtual sound source (virtual sound source relative coordinates) with respect to the position of the listening point based on the listening point position obtained by the listening point obtaining unit 201 and the virtual sound source coordinates received from the virtual sound source information DB 202.

The speaker information DB 204 stores speaker information about each of a plurality of speakers that constitute a speaker set 208. The speaker information includes information such as speaker coordinates in the actual world indicating the position where each speaker is located. The speaker information will be described in detail below. The second coordinates calculation unit 205 calculates relative coordinates of each speaker (speaker relative coordinates) with respect to the position of the listening point based on the listening point position obtained by the listening point obtaining unit 201 and the speaker coordinates received from the speaker information DB 204.

The sound source rendering unit 206 performs panning processing on the sound source signals output from the virtual sound source based on the position of the virtual sound source with respect to the position of the listening point and the position of each speaker with respect to the position of the listening point, thereby performing processing of distributing the sound source signals to the appropriately selected speakers. The sound source rendering unit 206 selects speakers to which the sound source signals output from the virtual sound source are distributed from among the plurality of speakers constituting the speaker set 208 based on the virtual sound source relative coordinates and the speaker relative coordinates, and performs processing of distributing the sound source signals to the selected speakers. The sound source rendering unit 206 performs the sound source signal distribution processing on each virtual sound source, and generates an output signal to be output to each of the speakers constituting the speaker set 208. The sound source rendering unit 206 is an example of a generation unit.

The sound source rendering unit 206 includes a panning calculation unit 211, a speaker set creation unit 212, an inverse matrix calculation unit 213, and a signal correction unit 214.

The panning calculation unit 211 distributes the input sound source signals from the virtual sound source to the appropriately selected speakers, thereby generating an output signal to be output to each speaker. The present exemplary embodiment illustrates an example where the panning calculation unit 211 performs panning calculation based on a Vector Based Amplitude Panning (VBAP) method that is a known method. In the VBAP method, the panning calculation unit 211 first calculates the product between a direction vector indicating a direction from the listening point to the virtual sound source and an inverse matrix obtained from the inverse matrix calculation unit 213. Next, the panning calculation unit 211 determines a speaker set to which the input sound source signals from the virtual sound source are distributed and a gain for each speaker based on the calculation result, and adds the sound source signals from the virtual sound source based on the speaker set and the gain, thereby generating an output signal to be output to each speaker.

The speaker set creation unit 212 creates a set of two adjacent speakers or a set of three adjacent speakers for all speakers based on the speaker relative coordinates. These speaker sets are created using a method compliant with the VBAP method. Specifically, the speaker set creation unit 212 creates a set of two speakers if the speakers are arranged two-dimensionally or arranged on a plane, and the speaker set creation unit 212 creates a set of three speakers if the speakers are arranged three-dimensionally or stereoscopically.

For example, in the case of creating a set of two speakers, the adjacent speakers as viewed from the listening point on the plane where the speakers are located are connected with a straight line to form a ring shape around the listening point. The speaker set creation unit 212 creates a set of two speakers connected with a straight line. For example, in the case of creating a set of three speakers, the speaker set creation unit 212 creates a set of three adjacent speakers as viewed from the listening point in the listening space surrounded by the speakers. In this case, the speaker set creation unit 212 creates a set of three speakers in such a manner that the planes formed by each speaker set do not overlap each other and the entire surface of the space surrounded by the speakers as viewed from the listening point is filled with the planes formed by each speaker set.

The inverse matrix calculation unit 213 creates a matrix of direction vectors to each speaker as viewed from the listening point for each speaker set created by the speaker set creation unit 212, and calculates the inverse matrix of the matrix of direction vectors. The signal correction unit 214 calculates an amount of correction for a sound pressure and delay of the output signal to be output to each speaker, which is output from the panning calculation unit 211, based on the distance between the listening point and each speaker, and corrects the output signal to be output to each speaker, as needed.

The acoustic reproduction unit 207 amplifies, as needed, the output signal to be output to each speaker, which is output from the sound source rendering unit 206, and outputs the amplified output signal to each of the speakers constituting the speaker set 208. The speaker set 208 consists of a plurality of speakers 210 located around a listening point 209 in such a manner that the speakers 210 surround the listening point 209. The speakers 210 transform the output signal amplified by the acoustic reproduction unit 207 into sound, and output and reproduce the sound, so that a sound field corresponding to the position of the listening point 209 is generated. In the present exemplary embodiment, the listening point 209 is freely movable in the space (listening space) surrounded by the plurality of speakers 210 constituting the speaker set 208. While FIG. 2 illustrates an example where a plurality of speakers is arranged three-dimensionally as the speaker set 208, the speaker set 208 is not limited to this example. A plurality of speakers may be arranged two-dimensionally as the speaker set 208.

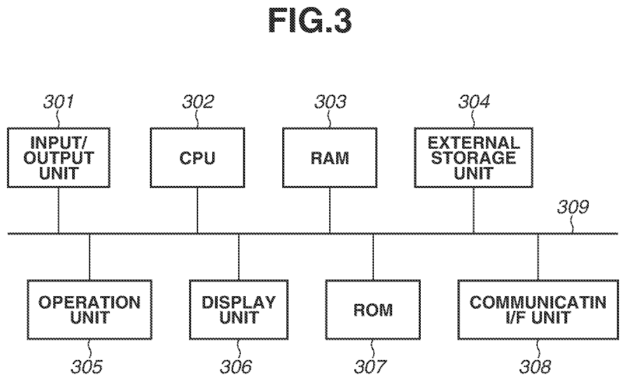

FIG. 3 is a block diagram illustrating a hardware configuration example of the control apparatus according to the first exemplary embodiment.

The control apparatus according to the first exemplary embodiment includes an input/output unit 301, a central processing unit (CPU) 302, a random access memory (RAM) 303, an external storage unit 304, an operation unit 305, a display unit 306, a read-only memory (ROM) 307, a communication interface (I/F) unit 308, and a bus 309. The input/output unit 301, the CPU 302, the RAM 303, the external storage unit 304, the operation unit 305, the display unit 306, the ROM 307, and the communication I/F unit 308 are interconnected via the bus 309 so that these components can communicate with each other.

The input/output unit 301 externally receives position sensor signals and sound source signals from virtual sound sources, and transmits the position sensor signals and the sound source signals to other components via the bus 309, as needed, according to an instruction from the CPU 302. The input/output unit 301 also transmits the generated output signal to be output to each speaker that is stored in the RAM 303 or the external storage unit 304 to an external apparatus via the bus 309, as needed, according to an instruction from the CPU 302. The CPU 302 controls the components of the control apparatus in an integrated manner. The CPU 302 sends control signals to other components via the bus 309 to control the components and perform various calculations according to programs. In the present exemplary embodiment, the CPU 302 executes processing according to the programs stored in the ROM 307 or the external storage unit 304, thereby executing the functions described above with reference to FIG. 2. The RAM 303 temporarily stores some of the programs being executed, accompanying data, calculation results from the CPU 302, and the like. The CPU 302 loads necessary programs and data into the RAM 303, and read and write data, as needed, to thereby execute programs.

The external storage unit 304 stores programs and data to be accumulated for a long period of time. For example, the functions of the virtual sound source information DB 202 and the speaker information DB 204 are implemented by the external storage unit 304. The external storage unit 304 is, for example, a hard disk drive (HDD) or a solid-state drive (SSD). The operation unit 305 receives various instruction operations from a user, converts the instruction operations into control signals, and transmits the control signals to the CPU 302 via the bus 309. The CPU 302 issues instructions to control programs being executed and control other components according to the control signals. The display unit 306 displays the state of each program being executed and the output of each program for the user. The ROM 307 stores programs for starting and ending the hardware devices, programs and the like for controlling basic input and output operations, fixed programs, and fixed parameters. The communication I/F unit 308 is configured to input and output data to and from a communication network, such as the Internet.

Various data configurations in the configuration according to the present exemplary embodiment will be described.

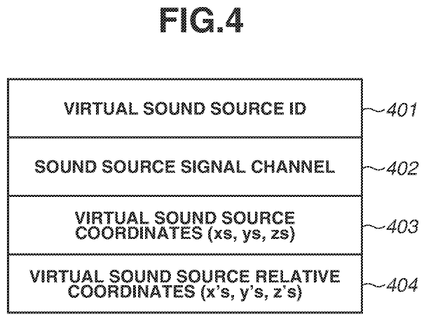

A data configuration of virtual sound source information will be described with reference to FIG. 4. FIG. 4 illustrates a data configuration example of virtual sound source information. As illustrated in FIG. 4, the virtual sound source information includes a virtual sound source identification (ID) 401, a sound source signal channel 402, a virtual sound source coordinates 403, and virtual sound source relative coordinates 404.

The virtual sound source ID 401 represents an ID number to identify the virtual sound source information, and is uniquely given to each piece of virtual sound source information, or each virtual sound source. The sound source signal channel 402 represents the number of a channel for each sound source signal associated with the virtual sound source among the channels of sound source signals to be input to the control apparatus. The virtual sound source coordinates 403 represent coordinates indicating the position of each virtual sound source as tree-dimensional coordinates in the virtual world in which a sound field is generated. In the present exemplary embodiment, for convenience of explanation, assume that the position of each virtual sound source is fixed and the virtual sound source coordinates 403 do not vary with time. However, the present exemplary embodiment is not limited to this example, and can also be applied to a case where the position of each virtual sound source varies with time. The virtual sound source relative coordinates 404 represent coordinates indicating the position of each visual sound source as viewed from the listening point, and are calculated in sound field generation processing and stored in this field.

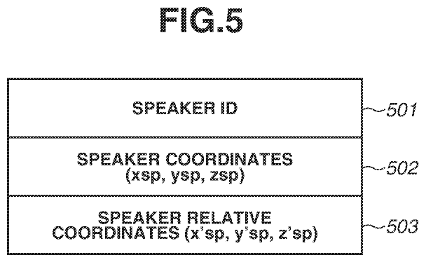

A data configuration of speaker information will be described with reference to FIG. 5. FIG. 5 illustrates a data configuration example of speaker information. As illustrated in FIG. 5, the speaker information includes a speaker ID 501, speaker coordinates 502, and speaker relative coordinates 503. The speaker ID 501 represents an ID number to identify the speaker information, and is uniquely given to each piece of speaker information, or each speaker. The speaker coordinates 502 represent coordinates indicating the position of each speaker as three-dimensional coordinates in the actual world. The speaker relative coordinates 503 represent coordinates indicating the position of each speaker as viewed from the listening point, and are calculated in sound field generation processing and stored in this field.

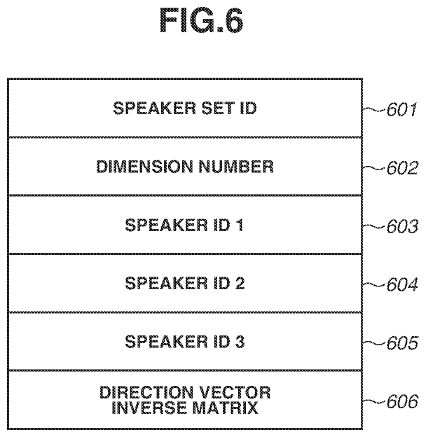

A data configuration of speaker set information will be described with reference to FIG. 6. FIG. 6 illustrates a data configuration example of speaker set information. FIG. 6 illustrates an example of speaker set information when the speakers are arranged three-dimensionally. As illustrated in FIG. 6, the speaker set information includes a speaker set ID 601, a dimension number 602, speaker IDs 603, 604, and 605, and a direction vector inverse matrix 606. The speaker set ID 601 indicates an ID number to identify the speaker set information, and is uniquely given to each piece of speaker set information. As the dimension number 602, information indicating whether the speakers are arranged two-dimensionally or three-dimensionally is stored. For example, as the dimension number 602, a value indicating whether the speakers are arranged two-dimensionally or three-dimensionally is stored and this value indicates the number of stored speaker IDs. The speaker IDs 603 to 605 represent speaker IDs for three speakers, respectively, that constitute the speaker set. The direction vector inverse matrix 606 represents the inverse matrix of the direction vector matrix created using direction vectors when the three speakers constituting the speaker set are viewed from the listening point, and is calculated by the inverse matrix calculation unit 213 and stored in this field. The speaker set information may include not only the direction vector inverse matrix, but also the direction vector matrix.

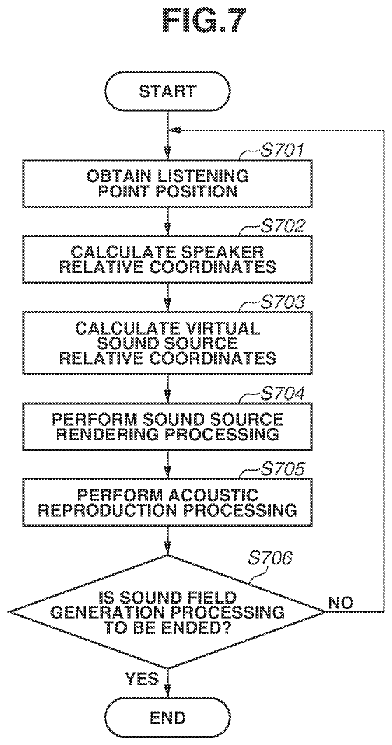

The sound field generation processing to be performed by the control apparatus according to the present exemplary embodiment will be described. FIG. 7 is a flowchart illustrating an example of the sound field generation processing to be performed by the control apparatus according to the present exemplary embodiment.

In step S701, the listening point obtaining unit 201 receives and analyzes signals from the position sensor (not illustrated), and obtains the position of the listening point in the actual world coordinate system. The listening point obtaining unit 201 outputs the listening point coordinates indicating the obtained listening point position to each of the first coordinates calculation unit 203 and the second coordinates calculation unit 205.

In step S702, the second coordinates calculation unit 205 obtains speaker information from the speaker information DB 204 and calculates relative coordinates of each speaker (speaker relative coordinates) as viewed from the listening point for each of the speakers constituting the speaker set 208. The second coordinates calculation unit 205 calculates speaker relative coordinates based on the listening point coordinates output from the listening point obtaining unit 201 and the speaker coordinates stored in the speaker information obtained from the speaker information DB 204. In the present exemplary embodiment, the speaker relative coordinates are represented as coordinates of each speaker in a three-dimensional coordinate system in which the listening point position is set as the center (reference, origin) and the direction of each axis matches the direction of each axis in the actual world coordinate system.

The speaker relative coordinates are obtained by simply subtracting the listening point coordinates from the speaker coordinates on each axis of the actual world coordinate system. For example, speaker coordinates in the actual world coordinate system are represented as (xsp, ysp, zsp), and listening point coordinates in the actual world coordinate system are represented as (xl, yl, zl). In this case, speaker relative coordinates (x′sp, y′sp, z′sp) are represented as (xsp-xl, ysp-yl, zsp-zl). The relative coordinates of each speaker calculated as described above are stored as the speaker relative coordinates 503 in the speaker information, and are output to the sound source rendering unit 206 for each speaker information.

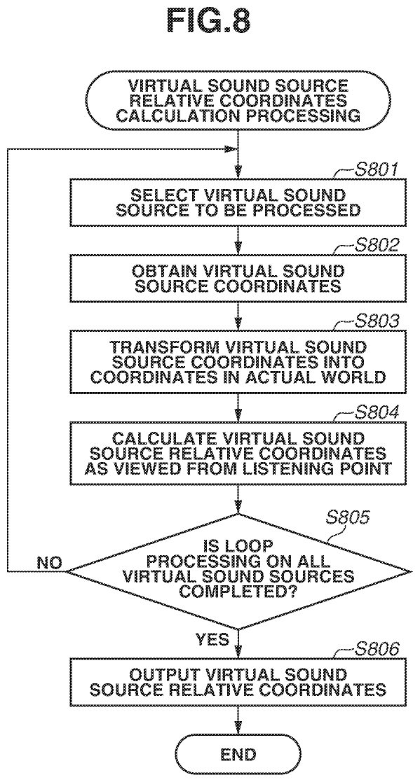

In step S703, the first coordinates calculation unit 203 obtains virtual sound source information from the virtual sound source information DB 202, performs virtual sound source relative coordinates calculation processing, and calculates the relative coordinates of each virtual sound source (virtual sound source relative coordinates) as viewed from the listening point. The first coordinates calculation unit 203 performs virtual sound source relative coordinates calculation processing on each virtual sound source located in the visual world. The first coordinates calculation unit 203 calculates virtual sound source relative coordinates based on the listening point coordinates in the actual world coordinate system output from the listening point obtaining unit 201 and the virtual sound source coordinates in the virtual world coordinate system stored in the virtual sound source information obtained from the virtual sound source information DB 202. Like the speaker relative coordinates, the virtual sound source relative coordinates according to the present exemplary embodiment are coordinates in a three-dimensional coordinate system in which the listening point position is set as the center (reference, origin) and the direction of each axis matches the direction of each axis in the actual world coordinate system. The virtual sound source relative coordinates calculation processing in step S703 will be described in detail below with reference to FIG. 8. The first coordinates calculation unit 203 outputs virtual sound source information about each virtual sound source, including the virtual sound source relative coordinates obtained through calculations, to the sound source rendering unit 206.

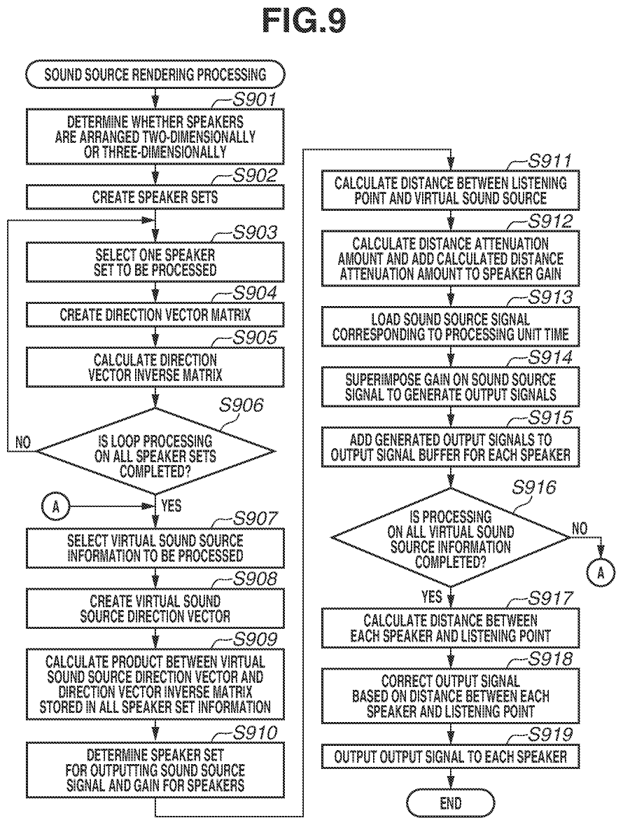

In step S704, the sound source rendering unit 206 performs sound source rendering processing and renders the sound source signals from each virtual sound source for each of the plurality of speakers constituting the speaker set 208, thereby generating a sound field. The sound source rendering unit 206 generates an output signal to be output to each speaker based on the speaker relative coordinates calculated in step S702 and the virtual sound source relative coordinates calculated in step S703, thereby generating the sound field. Then, the sound source rendering unit 206 outputs the generated output signal to be output to each speaker to the acoustic reproduction unit 207. The sound source rendering processing in step S704 will be described in detail below with reference to FIG. 9.

In step S705, the acoustic reproduction unit 207 performs sound adjustment and amplification processing (acoustic reproduction processing), as needed, on the output signal to be output to each speaker, which is output from the sound source rendering unit 206, and outputs electric signals to each of the speakers constituting the speaker set 208. The speakers constituting the speaker set 208 convert the input electric signals into sound to be output. As a result, a sound image of each virtual sound source to be sensed at the listening point can be generated at an accurate position corresponding to the position where the virtual sound source is located. The generation of the sound image of one or more virtual sound sources at an accurate position as viewed from the listening point makes it possible to generate the sound field corresponding to the listening point at the time.

In step S706, the control apparatus determines whether the sound field generation processing is to be ended by, for example, a user operation on the operation unit 305. If the control apparatus determines that the sound field generation processing is not ended (NO in step S706), the sound field generation processing is continuously performed and the processing returns to step S701 to obtain a listening point position and execute the sound field generation processing on the next listening point position. Thus, the control apparatus obtains the listening point position every processing unit time for a series of processes of steps S701 to S705, and generates the sound field of each virtual sound source corresponding to the obtained listening point position. If the control apparatus determines that the sound field generation processing is to be ended (YES in step S706), the sound field generation processing ends.

FIG. 8 is a flowchart illustrating an example of the virtual sound source relative coordinates calculation processing in step S703 illustrated in FIG. 7. All processes in the virtual sound source relative coordinates calculation processing illustrated in FIG. 8 are executed by the first coordinates calculation unit 203.

In the flowchart illustrated in FIG. 8, the processes of steps S801 to S805 are executed as loop processing on all virtual sound sources to be arranged.

In step S801, the first coordinates calculation unit 203 selects one virtual sound source to be processed from among one or more virtual sound sources located in the virtual world.

In step S802, the first coordinates calculation unit 203 searches the virtual sound source information DB 202 using the virtual sound source ID for the virtual sound source selected in step S801, and obtains the virtual sound source coordinates of the virtual sound source to be processed.

In step S803, the first coordinates calculation unit 203 transforms the virtual sound source coordinates described using the virtual world coordinate system obtained in step S802 into the coordinates in the actual world coordinate system. The transformation of the virtual sound source coordinates in the virtual world coordinate system into the virtual sound source coordinates in the actual world coordinate system is performed by, for example, general three-dimensional coordinate transform calculations. For example, virtual sound source coordinates in the virtual world coordinate system of the virtual sound source to be processed are represented as (xs, ys, zs). When the virtual world coordinate system is rotated in the order of an angle γ about a Z-axis, an angle β about a Y-axis, an angle α about an X-axis, the direction of each axis in the virtual world coordinate system matches the direction of each axis in the actual world coordinate system. In this case, assume that the origin of each coordinate system is shifted by x, y, and z on the X-axis, the Y-axis, and the Z-axis, respectively, in the actual world coordinate system. In this case, virtual sound source coordinates (xsa, ysa, zsa) in the actual world coordinate system may be calculated by the following equation.

$$( \begin{matrix}xsa \\ ysa \\ zsa\end{matrix} ) = ( \begin{matrix}cos γ & sin γ & 0 \\ - sin γ & cos γ & 0 \\ 0 & 0 & 1\end{matrix} ) ( \begin{matrix}cos β & 0 & - sin β \\ 0 & 1 & 0 \\ sin β & 0 & cos β\end{matrix} ) ( \begin{matrix}1 & 0 & 0 \\ 0 & cos α & sin α \\ 0 & - sin α & cos α\end{matrix} ) ( \begin{matrix}xs - x \\ ys - y \\ zs - z\end{matrix} ) \qquad ( 1 )$$

In step S804, the first coordinates calculation unit 203 calculates relative coordinates of each virtual sound source (virtual sound source relative coordinates) as viewed from the listening point. The first coordinates calculation unit 203 calculates virtual sound source relative coordinates based on the virtual sound source coordinates in the actual world coordinate system obtained in step S803 and the listening point coordinates in the actual world coordinate system obtained in step S701 illustrated in FIG. 7. Like the speaker relative coordinates, the virtual sound source relative coordinates can be obtained by simply subtracting the listening point coordinates from the virtual sound source coordinates on each axis of the actual world coordinate system. For example, when the listening point coordinates in the actual world coordinate system are represented as (xl, yl, zl), the relative coordinates (x's, y's, z's) of the virtual sound source to be processed are represented as (xsa-xl, ysa-yl, zsa-zl). The virtual sound source relative coordinates calculated as described above are stored as the virtual sound source relative coordinates 404 in the virtual sound source information about the virtual sound source to be processed.

In step S805, the first coordinates calculation unit 203 determines whether the loop processing on all virtual sound sources is completed. If the first coordinates calculation unit 203 determines that there are virtual sound sources that are not processed yet (NO in step S805), the processing returns to step S801 to select one of virtual sound sources that are not processed yet and execute the loop processing on the subsequent virtual sound source. On the other hand, if the first coordinates calculation unit 203 determines that the loop processing on all virtual sound sources is completed (YES in step S805), the processing proceeds to step S806.

In step S806, the first coordinates calculation unit 203 outputs the virtual sound source information about all virtual sound sources, which includes the virtual sound source relative coordinates and is stored in the RAM 103, to the sound source rendering unit 206. After completion of the processing of step S806, the virtual sound source relative coordinates calculation processing ends. Then, the processing returns to the sound field generation processing illustrated in FIG. 7.

FIG. 9 is a flowchart illustrating an example of the sound source rendering processing in step S704 illustrated in FIG. 7. All processes in the sound source rendering processing illustrated in FIG. 9 are executed by the sound source rendering unit 206.

In step S901, the speaker set creation unit 212 in the sound source rendering unit 206 determines whether the speakers of the speaker set 208 are arranged two-dimensionally or three-dimensionally. The speaker set creation unit 212 determines whether the speakers are arranged two-dimensionally or three-dimensionally using, for example, the speaker relative coordinates output from the second coordinates calculation unit 205 in step S702 illustrated in FIG. 7.

In step S902, the speaker set creation unit 212 creates a speaker set based on the determination result in step S901. If it is determined that the speakers are arranged two-dimensionally, the speaker set creation unit 212 creates a set of two speakers. If it is determined that the speakers are arranged three-dimensionally, the speaker set creation unit 212 creates a set of three speakers. The speaker set creation unit 212 generates the speaker set information as illustrated in FIG. 6, including the speaker IDs for the respective speakers constituting the speaker set. Then, the speaker set creation unit 212 outputs the speaker set information and the relative coordinates of each speaker to the inverse matrix calculation unit 213.

The subsequent processes of steps S903 to S906 are executed as loop processing on all speaker sets created in step S902. The processes of steps S903 to S906 are executed by the inverse matrix calculation unit 213 in the sound source rendering unit 206.

In step S903, the inverse matrix calculation unit 213 in the sound source rendering unit 206 selects one speaker set to be processed from all speaker sets created in step S902. For example, the inverse matrix calculation unit 213 selects one speaker set to be processed in the order of IDs, for example, based on the speaker set IDs stored in the speaker set information.

In step S904, the inverse matrix calculation unit 213 creates a direction vector matrix for the speaker set selected in step S903. The inverse matrix calculation unit 213 first calculates a unit vector from the listening point to the speaker relative coordinates, that is, a direction vector indicating the direction of each speaker as viewed from the listening point, based on the speaker relative coordinates of each of the speakers constituting the speaker set. The unit vector can be obtained by multiplying the coordinate values of the speaker relative coordinates by the same magnification so that the size of the vector becomes “1”. For example, if the speakers are arranged three-dimensionally, a direction vector v for each speaker indicated by speaker relative coordinates (x, y, z) may be calculated by the following equation.

$$v = ( \frac{x}{\sqrt{{x}^{2} + {y}^{2} + {z}^{2}}} , \frac{y}{\sqrt{{x}^{2} + {y}^{2} + {z}^{2}}} , \frac{z}{\sqrt{{x}^{2} + {y}^{2} + {z}^{2}}} ) \qquad ( 2 )$$

Next, the inverse matrix calculation unit 213 creates a direction vector matrix by arranging the direction vectors in a row. Accordingly, if the speakers are arranged two-dimensionally, the direction vector matrix is created as a 2×2 square matrix, and if the speakers are arranged three-dimensionally, the direction vector matrix is created as a 3×3 square matrix.

In step S905, the inverse matrix calculation unit 213 calculates the inverse matrix of the direction vector matrix created in step S904. The obtained inverse matrix is stored in the speaker set information about the speaker set to be processed.

In step S906, the inverse matrix calculation unit 213 determines whether the loop processing on all speaker sets is completed. If the inverse matrix calculation unit 213 determines that there are speaker sets that are not processed yet (NO in step S906), the processing returns to step S903 to select one of the speaker sets that are not processed yet and execute the processing on the subsequent speaker set. On the other hand, if the inverse matrix calculation unit 213 determines that the loop processing on all speaker sets is completed (YES in step S906), the speaker set information about all speaker sets is output to the panning calculation unit 211, and then the processing proceeds to step S907.

The subsequent processes of steps S907 to S916 are executed as loop processing on all virtual sound source information output from the first coordinates calculation unit 203 in step S703 illustrated in FIG. 7, or on all virtual sound sources to be arranged. The processes of steps S907 to S916 are executed by the panning calculation unit 211 in the sound source rendering unit 206.

In step S907, the panning calculation unit 211 in the sound source rendering unit 206 selects one piece of virtual sound source information to be processed from one or more pieces of virtual sound source information output from the first coordinates calculation unit 203 in step S703 illustrated in FIG. 7.

In step S908, the panning calculation unit 211 creates a virtual sound source direction vector as a unit vector from the listening point to the virtual sound source relative coordinates using the virtual sound source relative coordinates stored in the virtual sound source information selected in step S907.

In step S909, the panning calculation unit 211 calculates the product between the virtual sound source direction vector created in step S908 and the inverse matrix of the direction vector matrix stored in all pieces of speaker set information. As a result of this calculation, if the speakers are arranged two-dimensionally, two values are obtained, and if the speakers are arranged three-dimensionally, three values are obtained. A case where the speakers are arranged three-dimensionally is described below. Also, in a case where the speakers are arranged two-dimensionally, the same processing can be applied except that two values are used as target values, instead of using three values.

In step S910, the panning calculation unit 211 determines a speaker set to which sound source signals are output and a gain for each of the speakers constituting the speaker set based on the result obtained in step S909.

The panning calculation unit 211 determines a speaker set to which sound source signals are output as described below, for example. First, the panning calculation unit 211 excludes the speaker sets in which a negative value is included as the value obtained as a result of calculation in step S909 from the selection candidates. Next, the panning calculation unit 211 calculates the differences of the three values in the speaker sets remaining as the selection candidates, and selects the speaker set with the largest difference. This selection processing makes it possible to determine a set of three speakers to which the sound source signals associated with the virtual sound source to be processed are distributed.

The panning calculation unit 211 determines the gain for each speaker, for example, in the manner as described below. The panning calculation unit 211 calculates the mean square of three values calculated for the speaker set selected as the speaker set to which the sound source signals are output, that is, the root sum square of the three values. This corresponds to the sum of energy. Accordingly, the gain for signals to be distributed to each speaker of the speaker set can be determined by dividing the three values by the mean square.

In step S911, the panning calculation unit 211 calculates a distance between the listening point and the virtual sound source using the virtual sound source relative coordinates stored in the virtual sound source information selected in step S907.

In step S912, the panning calculation unit 211 calculates a distance attenuation amount of a sound pressure based on the distance between the listening point and the virtual sound source calculated in step S911, and adds the calculated distance attenuation amount to the gain for each speaker obtained in step S910. For example, assuming that a reference distance is represented by ro [m], the distance between the listening point and the virtual sound source is represented by r1 [m], the virtual space to be subjected to the sound field generation processing is a free space, and the virtual sound source is a point sound source, a distance attenuation amount D can be calculated by the following equation.

$$D = 20 log ( ro / r 1 ) [ dB ] \qquad ( 3 )$$

In step S913, the panning calculation unit 211 reads the sound source signal corresponding to the processing unit time corresponding to a time for a series of processes of steps S701 to S705 in the sound field generation processing illustrated in FIG. 7 into a prescribed area in the RAM 303. The sound source signal is a channel signal designated by a sound source channel in the virtual sound source information to be processed selected in step S907. This sound source signal may be stored in a file. In this case, the previous file reading position may be stored in the RAM 303, and the signal corresponding to the processing unit time may be read out from the position. Alternatively, the sound source signal that is input in real time and corresponds to the processing unit time may be read immediately after the previous reading time.

In step S914, the panning calculation unit 211 superimposes the gain for each speaker calculated in step S912 on the sound source signal read in step S913, thereby generating an output signal to be output to each speaker.

In step S915, the panning calculation unit 211 adds the output signal to be output to each speaker generated in step S914 to an output signal buffer for each speaker. The output signal to be output to each speaker is added for each speaker, and a plurality of sound source signals is distributed to the speakers, respectively. Thus, the plurality of sound source signals from the virtual sound source can be arranged in an accurate direction as viewed from the listening point and can be simultaneously reproduced, so that the sound field corresponding to the listening point can be generated.

In step S916, the panning calculation unit 211 determines whether the processing on all pieces of virtual sound source information output from the first coordinates calculation unit 203 in step S703 illustrated in FIG. 7 is completed. If the panning calculation unit 211 determines that there are pieces of virtual sound source information that are not processed yet (NO step S916), the processing returns to step S907 to select one of the pieces of virtual sound source information that are not processed yet and execute the processing on the subsequent virtual sound source information. On the other hand, if the panning calculation unit 211 determines that the processing on all pieces of virtual sound source information is completed (YES in step S916), the processing proceeds to step S917.

In step S917, the signal correction unit 214 in the sound source rendering unit 206 calculates the distance between each speaker and the listening point. The signal correction unit 214 calculates the distance between each speaker and the listening point using, for example, the speaker relative coordinates output from the second coordinates calculation unit 205 in step S702 illustrated in FIG. 7.

In step S918, the signal correction unit 214 calculates the amount of correction for the sound pressure and delay of sound output from each speaker based on the distance between each speaker and the listening point calculated in step S917, and corrects the output signal to be output to each speaker. Consequently, the output signal to be output to each speaker at the listening point can be optimized, so that the sound image can be reproduced at an accurate position.

In step S919, the sound source rendering unit 206 outputs the output signal to be output to each speaker stored in the output signal buffer for each speaker to the acoustic reproduction unit 207. After the processing of step S919, the sound source rendering processing ends. Then, the processing returns to the sound field generation processing illustrated in FIG. 7.

As described above, the distribution of the sound source signals from the virtual sound source to each speaker is appropriately changed so that the sound image to be sensed at the listening point matches the position of the virtual sound source in accordance with the movement of the listening point, thereby making it possible to present the sound image at the position of the virtual sound source even after the listening point has moved.

According to the present exemplary embodiment, the position of the listening point is obtained every processing unit time, and the position of the virtual sound source with respect to the position of the listening point and the position of each speaker with respect to the position of the listening point are calculated. The sound source signals from the virtual sound source are distributed to each speaker based on the calculated positions. Thus, even after the listening point has moved, the sound field of the virtual sound source corresponding to the position of the listening point can be generated. Therefore, even after the listening point has moved, the sound image of the virtual sound source can be presented at an accurate position as viewed from the listening point as if the virtual sound source were present at the position.

The first exemplary embodiment described above illustrates an example where the sound field corresponding to the listening point position is generated based on the virtual sound source located in the virtual space in the listening space surrounded by speakers. A second exemplary embodiment illustrates an example where not only the sound field of the virtual sound source is generated, but also a three-dimensional video image of the virtual space corresponding to the listening point is generated and reproduced. Descriptions of configurations and processing of the second exemplary embodiment that are similar to those of the first exemplary embodiment are omitted.

Assume that a control apparatus according to the second exemplary embodiment operates in cooperation with a virtual viewpoint video image generation apparatus that generates a video image (virtual viewpoint video image) when a virtual camera is located at an arbitrary position in the virtual space in which an object and a background are located. Coordinates indicating the position of the virtual camera are externally input to the control apparatus.

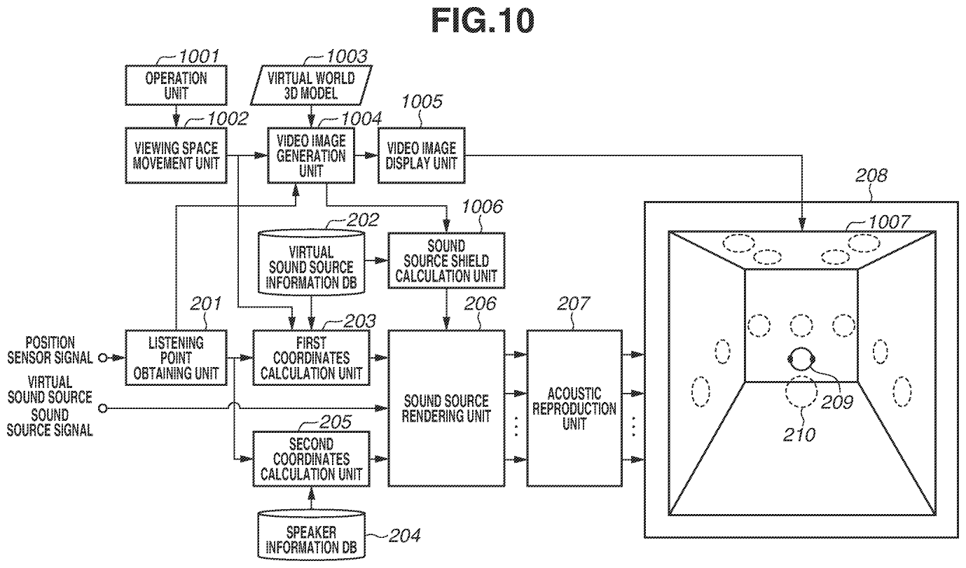

FIG. 10 is a block diagram illustrating a functional configuration example of the control apparatus according to the second exemplary embodiment. In FIG. 10, components having the same functions as the components illustrated in FIG. 2 are denoted by the same reference numerals, and redundant descriptions are omitted. The control apparatus according to the second exemplary embodiment includes the listening point obtaining unit 201, the virtual sound source information DB 202, the first coordinates calculation unit 203, the speaker information DB 204, the second coordinates calculation unit 205, the sound source rendering unit 206, and the acoustic reproduction unit 207. The control apparatus according to the second exemplary embodiment also includes an operation unit 1001, a viewing space movement unit 1002, a video image generation unit 1004, a video image display unit 1005, and a sound source shield calculation unit 1006.

The operation unit 1001 receives a user operation to freely move the viewing space surrounding by speakers. The user operation input to the operation unit 1001 is converted into a movement command to be transmitted to the viewing space movement unit 1002. The viewing space movement unit 1002 causes the viewing space to move in the virtual space based on the received movement command, calculates coordinates in the virtual space of the viewing space after movement, and outputs the calculated coordinates to the video image generation unit 1004.

The video image generation unit 1004 moves the viewing space to the coordinates designated by the viewing space movement unit 1002, and generates, using a virtual world three-dimensional (3D) model 1003, a three-dimensional video image of the virtual world as viewed from the position of the listening point obtained by the listening point obtaining unit 201. The virtual world 3D model 1003 includes 3D data on constituent objects constituting the virtual world and layout information. The video image generated by the video image generation unit 1004 is output to the video image display unit 1005. The video image display unit 1005 performs, for example, color adjustment processing for display on the three-dimensional video image of the virtual world generated by the video image generation unit 1004, and split processing to display the three-dimensional video image of the virtual world on a plurality of displays, and outputs and displays the video image on a multi-display 1007.

The sound source shield calculation unit 1006 calculates a shielding situation where the sound source object is shielded by a shield in the video image of the virtual world generated by the video image generation unit 1004 based on the virtual sound source information about each virtual sound source obtained from the virtual sound source information DB 202. The sound source shield calculation unit 1006 outputs the calculation result of the shielding situation where the sound source object is shielded by the shield to the sound source rendering unit 206.

The multi-display 1007 is composed of a plurality of light-emitting diode (LED) displays, projection displays, or the like. The multi-display 1007 displays the video image of the virtual world output from the video image display unit 1005 on the inside of the viewing space. With this configuration, a system according to the present disclosure enables the listener located at the listening point 209 to be visually immersed in a virtual world. FIG. 10 illustrates a case where five displays are placed in a state where the speakers 210 constituting the speaker set 208 are hidden. The state where the speakers 210 are hidden is indicated by dotted-line areas. Sound from each speaker 210 transmits through the displays, or each speaker 210 is embedded in the displays and sound from each speaker 210 is output from the surface of each display.

A hardware configuration example of the control apparatus according to the second exemplary embodiment is similar to that of the first exemplary embodiment, and thus the descriptions thereof are omitted.

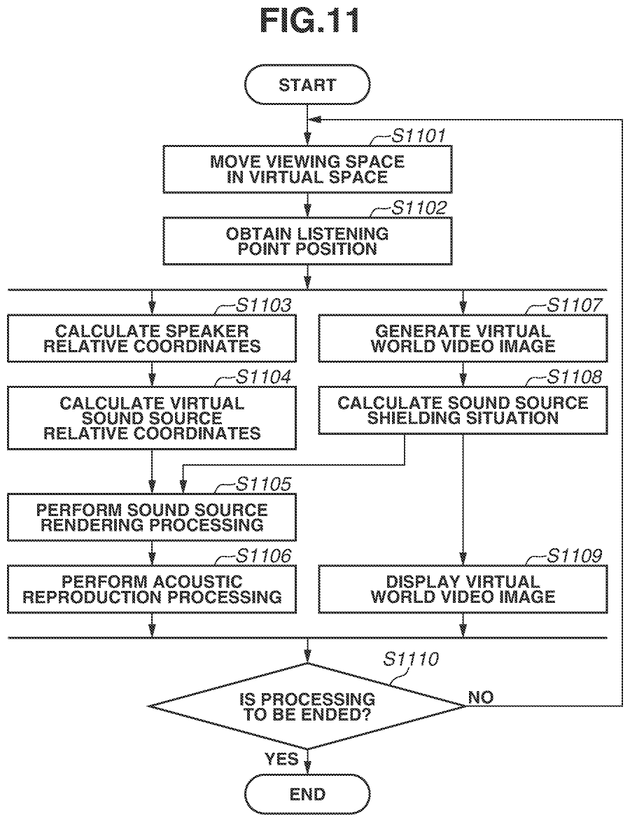

Processing to be performed by the control apparatus according to the second exemplary embodiment will be described. FIG. 11 is a flowchart illustrating an example of sound field/video image generation processing to be performed by the control apparatus according to the second exemplary embodiment.

In step S1101, the viewing space movement unit 1002 performs processing of causing the viewing space to move in the virtual space according to a user operation instruction input through the operation unit 1001. The viewing space movement unit 1002 changes the coordinates and direction in the virtual space of a reference point set in the viewing space according to a user operation instruction input through the operation unit 1001. This processing is known processing that is generally performed, for example, in the field of games using three-dimensional computer graphics (3DCG), and thus the description thereof is omitted. The viewing space movement unit 1002 outputs the changed coordinates and direction of the viewing space to each of the video image generation unit 1004 and the first coordinates calculation unit 203.

The process of step S1102 is similar to the process of step S701 illustrated in FIG. 7 according to the first exemplary embodiment, and thus the description thereof is omitted.

The processes of steps S1103 to S1106 and the processes of steps S1107 to S1109 are executed in parallel. In this case, however, it may be desirable to complete the process of step S1108 before executing the process of step S1105.

The processes of steps S1103 and S1104 are respectively similar to the processes of step S702 to S703 illustrated in FIG. 7 according to the first exemplary embodiment, and thus the descriptions thereof are omitted.

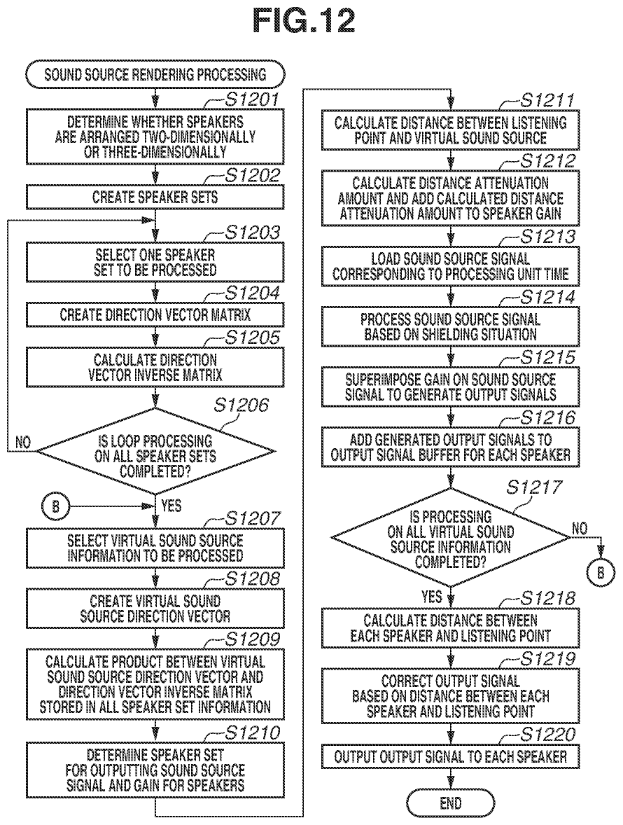

In step S1105, the sound source rendering unit 206 performs the sound source rendering processing to render the sound source signals from each virtual sound source for the plurality of speakers constituting the speaker set 208, thereby generating a sound field. The sound source rendering unit 206 generates an output signal to be output to each speaker based on the speaker relative coordinates calculated in step S1103 and the virtual sound source relative coordinates calculated in step S1104. In this case, the sound source rendering unit 206 renders the sound source signals from each virtual sound source in consideration of the shielding situation for each virtual sound source calculated in step S1108. In the manner as described above, the output signal to be output to each of the speakers constituting the sound field at the listening point is generated and the generated output signal to be output to each speaker is output to the acoustic reproduction unit 207. The sound source rendering processing in step S1105 will be described in detail below with reference to FIG. 12.

The process of step S1106 is similar to the process of step S705 illustrated in FIG. 7 according to the first exemplary embodiment, and thus the description thereof is omitted.

In step S1107, the video image generation unit 1004 generates a video image of the virtual world using the virtual world 3D model 1003. The video image generation unit 1004 calculates listening point coordinates in the virtual space based on the coordinates and direction of the viewing space output from the viewing space movement unit 1002 in step S1101 and the listening point position obtained by the listening point obtaining unit 201 in step S1102. The video image generation unit 1004 generates the video image of the virtual world to be displayed on the multi-display 1007 using the virtual world 3D model 1003 based on the calculated and obtained listening point coordinates in the virtual space. This processing is known processing that is generally performed in the field of video image generation using 3DCG, and thus the description thereof is omitted.

In step S1108, the sound source shield calculation unit 1006 obtains virtual sound source information about each virtual sound source from the virtual sound source information DB 202, and calculates the virtual sound source object shielding situation in the video image of the virtual world generated in step S1107. The sound source shield calculation unit 1006 determines whether there is any other object that shields the sound source in the video image of the virtual world generated in step S1107 for each virtual sound source object based on the virtual sound source information about each virtual sound source. If there is any other object that shields the virtual sound source, the sound source shield calculation unit 1006 analyzes and calculates what shields the virtual sound source and the ratio at which the sound source is shielded. For example, an analysis result indicating that the virtual sound source is shielded by a tree and 40% of the virtual sound source is shielded is obtained. Then, the sound source shield calculation unit 1006 outputs the obtained result to the sound source rendering unit 206.

In step S1109, the video image display unit 1005 causes the multi-display 1007 to output and display, as needed, the video image of the virtual world generated in step S1107. As a result, the video image of the virtual world as viewed from the listening point is displayed on the multi-display 1007, thereby enabling the listener located at the listening point 209 to be visually immersed in the virtual world.

FIG. 12 is a flowchart illustrating an example of the sound source rendering processing in step S1105 illustrated in FIG. 11. All processes in the sound source rendering processing illustrated in FIG. 12 are executed by the sound source rendering unit 206.

The processes of steps S1201 to S1213 are respectively similar to the processes of steps S901 to S913 illustrated in FIG. 9 according to the first exemplary embodiment, and thus the descriptions thereof are omitted.

In step S1214, the sound source rendering unit 206 processes the sound source signal from the virtual sound source read in step S1213 based on the shielding situation of the virtual sound source to be processed calculated in step S1108 illustrated in FIG. 11. For example, if the virtual sound source is shielded by a tree, an acoustic characteristic filter in which acoustic characteristics associated with shielding of the virtual sound source by a tree are reflected is applied. If the shielding ratio is 40%, a process to set the sound pressure to 60% is performed on the sound source signal.

The processes of steps S1215 to S1220 are respectively similar to the processes of steps S914 to S919 illustrated in FIG. 9 according to the first exemplary embodiment, and thus the descriptions thereof are omitted.

While the present exemplary embodiment described above illustrates an example where the three-dimensional video image of the virtual world to be generated is displayed on the multi-display 1007, the present exemplary embodiment is not limited to this example. For example, the three-dimensional video image of the virtual world may be displayed on a head-mounted display (HMD) that is wearable by the user.

According to the present exemplary embodiment, even after the listening point has moved, the video image of the virtual space as viewed from the listening point and the sound image of each virtual sound source at an accurate position as viewed from the listening point, like in the first exemplary embodiment can be presented. Further, if the sound source set as an object in the video image of the virtual space is shielded by another object, acoustic processing is performed in consideration of the shielding situation. Consequently, the sound image of each virtual sound source that can be seen in the virtual space can be presented as if the virtual sound source were present at the position, thereby further enhancing the sense of immersion in the virtual world at the listening point.

The drawings according to the exemplary embodiments described above illustrate an example where speakers are arranged three-dimensionally. However, the speaker layout is not limited to this example. The speakers may be arranged two-dimensionally. The exemplary embodiments described above illustrate an example where the position of the listening point is obtained every processing unit time, and the position of the virtual sound source with respect to the position of the listening point and the position of each speaker with respect to the position of the listening point are calculated. However, some embodiments are not limited to this example. If it is detected that the position of the listening point has moved, the position of the virtual sound source with respect to the position of the listening point and the position of each speaker with respect to the position of the listening point may be calculated again, and already calculated values may be used for the other values to be used.

### OTHER EXEMPLARY EMBODIMENTS

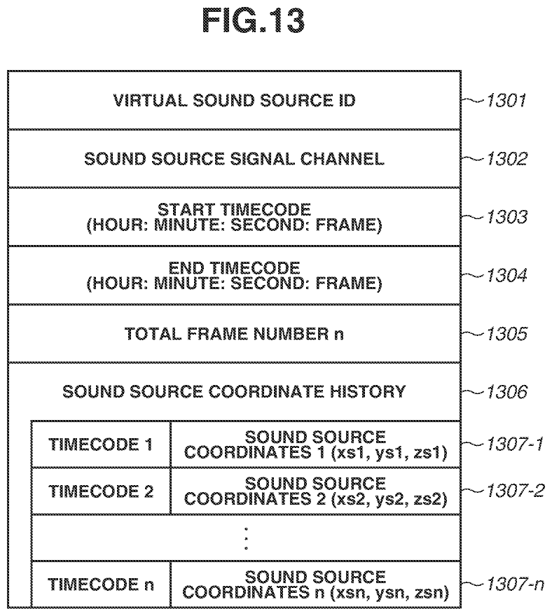

In the exemplary embodiments described above, the position of each virtual sound source to be arranged (virtual sound source coordinates) is fixed. The above-described exemplary embodiments can also be applied to a case where the virtual sound source moves. For example, virtual sound source coordinates obtained by adding a time to the virtual sound source information about each virtual sound source may be stored, and the virtual sound source coordinates corresponding to the time may be obtained. FIG. 13 illustrates a data configuration example of virtual sound source information in this case. As illustrated in FIG. 13, the virtual sound source information obtained in this case includes a virtual sound source ID 1301, a sound source signal channel 1302, a start timecode 1303, an end timecode 1304, a total frame number n 1305, and a sound source coordinate history 1306.

The virtual sound source ID 1301 represents an ID number for identifying the virtual sound source information, and is uniquely given to each piece of virtual sound source information, or each virtual sound source. The sound source signal channel 1302 represents the number of a channel for each sound source signal associated with the virtual sound source among the channels of sound source signals to be input to the control apparatus. The start timecode 1303 represents a head timecode in the sound source coordinate history stored in the virtual sound source information. The end timecode 1304 represents a last timecode in the sound source coordinate history stored in the virtual sound source information. The total frame number n 1305 represents the number of elements of the sound source coordinate history. The sound source coordinate history 1306 includes a number of sets 1307-1, 1307-2, . . . , and 1307-n of a timecode and sound source coordinates corresponding to the total number of frames. The virtual sound source information is configured as described above, thereby obtaining the virtual sound source coordinates in each timecode.

In the exemplary embodiments described above, panning processing based on the VBAP method is performed. The same processing can also be performed using other panning algorithms. In the exemplary embodiments described above, the virtual sound source coordinates are obtained from the virtual sound source information DB 202. Alternatively, a system for obtaining in real time the actual position of each virtual sound source set as an object may be used in combination and coordinates obtained from the system may be used as the virtual sound source coordinates.

Some embodiments can also be implemented by the following processing. That is, a program for implementing one or more functions according to the exemplary embodiments described above is supplied to a system or an apparatus via a network or a storage medium, and one or more processors in a computer of the system or the apparatus read out and execute the program. Some embodiments can also be implemented by a circuit (e.g., an application-specific integrated circuit (ASIC) for implementing one or more functions according to the exemplary embodiments.

The above-described exemplary embodiments are merely illustrative of embodiments for carrying out the present disclosure, and the technical scope of the present disclosure should not be interpreted in a limited way based on the exemplary embodiments. That is, embodiments of the present disclosure can be carried out in various forms without departing from the technical idea or main features of the present disclosure.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-029726, which was filed on Feb. 28, 2023 and which is hereby incorporated by reference herein in its entirety.

What is claimed is:

1. A control apparatus comprising:
one or more memories storing instructions; and
one or more processors executing the instructions to:
obtain a position of a listening point;
calculate a respective position of each of one or more virtual sound sources with respect to the obtained position of the listening point;
calculate positions of a plurality of speakers with respect to the obtained position of the listening point, the plurality of speakers being located around the listening point;
generate an output signal to be output to each of the plurality of speakers based on one or more sound source signals each output from the one or more virtual sound sources, the respective position of each of the one or more virtual sound sources with respect to the position of the listening point, and the positions of the plurality of speakers with respect to the position of the listening point; and
cause each of the plurality of speakers to reproduce sound corresponding to the output signal.

2. The control apparatus according to claim 1, wherein the one or more processors further execute the instructions to generate the output signal to be output to each of the plurality of speakers by distributing the sound source signal to the plurality of speakers based on the respective position of each of the one or more virtual sound sources with respect to the position of the listening point and the positions of the plurality of speakers with respect to the position of the listening point.

3. The control apparatus according to claim 2, wherein the one or more processors further execute the instructions to select a set of speakers to which the sound source signal is distributed, from among the plurality of speakers based on the respective position of each of the one or more virtual sound sources with respect to the position of the listening point and the positions of the plurality of speakers with respect to the position of the listening point, and to distribute the sound source signal to the selected set of speakers.

4. The control apparatus according to claim 1, wherein the one or more processors further execute the instructions to:
create a set of adjacent speakers as viewed from the obtained position of the listening point;
calculate an inverse matrix using a vector indicating a direction of each of the plurality of speakers as viewed from the position of the listening point for each set of the speakers; and
generate an output signal to be output to each of the plurality of speakers by determining a set of the speakers to which the sound source signal is distributed based on the inverse matrix and the respective position of each of the one or more virtual sound sources with respect to the position of the listening point.

5. The control apparatus according to claim 1, wherein the one or more processors further execute the instructions to correct the output signal to be output to each of the plurality of speakers based on a distance between the listening point and each of the plurality of speakers.

6. The control apparatus according to claim 5, wherein the one or more processors further execute the instructions to perform correction processing related to at least one of a sound pressure and a delay.

7. The control apparatus according to claim 1, wherein the one or more processors further execute the instructions to:
generate a three-dimensional video image of a virtual space as viewed from the position of the listening point; and
display the generated three-dimensional video image of the virtual space within a space in which the plurality of speakers is located.

8. The control apparatus according to claim 7, wherein the one or more processors further execute the instructions to adjust the output signal to be output to each of the plurality of speakers based on a shielding situation where the one or more virtual sound sources are shielded by a shield in the generated three-dimensional video image of the virtual space.

9. The control apparatus according to claim 1, further comprising the plurality of speakers.

10. A control method for a control apparatus, comprising:
obtaining a position of a listening point;
calculating a respective position of each of one or more virtual sound sources with respect to the obtained position of the listening point;
calculating positions of a plurality of speakers with respect to the obtained position of the listening point, the plurality of speakers being located around the listening point;
generating output signals to be output to each of the plurality of speakers based on sound source signals each output from the one or more virtual sound sources, the respective position of each of the one or more virtual sound sources with respect to the position of the listening point, and the positions of the plurality of speakers with respect to the position of the listening point; and
causing each of the plurality of speakers to reproduce sound corresponding to the output signal.

11. A non-transitory computer readable medium storing a program for causing a control apparatus to execute a control method, the control method comprising:
obtaining a position of a listening point;
calculating a respective position of each of one or more virtual sound sources with respect to the obtained position of the listening point;
calculating positions of a plurality of speakers with respect to the obtained position of the listening point, the plurality of speakers being located around the listening point;
generating output signals to be output to each of the plurality of speakers based on sound source signals each output from the one or more virtual sound sources, the respective position of each of the one or more virtual sound sources with respect to the position of the listening point, and the positions of the plurality of speakers with respect to the position of the listening point; and
causing each of the plurality of speakers to reproduce sound corresponding to the output signal.
